(19) United States
(12) Patent Application Publication
(10) Pub. No.: US 2014/0084747 A1
(43) Pub. Date: Mar. 27, 2014

(54) ELECTROMECHANICAL CONVERTER HAVING A TWO-LAYER BASE ELEMENT, AND PROCESS FOR THE PRODUCTION OF SUCH AN ELECTROMECHANICAL CONVERTER

(71) Applicants: Ludwig Jenninger, (US); Maria Jenninger, Ahorn-Berolzheim (DE)

(72) Inventors: Deliani Lovera-Prieto, Koln (DE); Ernst Ulrich Reisner, Moers (DE); Werner Jenninger, Koln (DE); Joachim Wagner, Koln (DE)

(73) Assignee: BAYER INTELLECTUAL PROPERTY GMBH, Monheim (DE)

(21) Appl. No.: 13/881,748

(22) PCT Filed: Oct. 25, 2011
(86) PCT No.: PCT/EP11/68598

§ 371 Date: Oct. 21, 2013

(30) Foreign Application Priority Data
Oct. 26, 2010 (EP) 10188793.3

(51) Int. Cl. H02N 1/10

(52) U.S. Cl. CPC H02N 1/10
USPC 310/300; 156/60; 156/272.2

(57) ABSTRACT

The present invention relates to electromechanical converters at least comprising a polymer layer composite with voids (5) formed therein, wherein the polymer layer composite at least comprises
a polymer layer base element (1) comprising a carrier layer (1a) having a softening temperature Tg_{A} and en electret layer (1b), extensively bonded thereto, having a softening temperature Tg_{E}, wherein Tg_{A}>Tg_{E}, and
a second polymer layer element (2), wherein
   the polymer layer base element (1) is at least partially bonded with its electret layer (1b) to the second polymer layer element (2) to form voids (5). The invention relates further to a process for the production of an electromechanical, for example piezoelectric, converter and to the use thereof.

The present invention relates to an electromechanical converter having a two-layer polymer layer base element, and to a process for the production thereof. The invention further relates also to the use of such an electromechanical converter.

Electromechanical converters use the ability of some materials to produce an electric potential in response to an applied mechanical load. This property is referred to as piezoelectricity. Established piezoelectric materials are lead zirconate titanate (PZT) and fluorinated polymers such as polyvinylidene fluoride (PVDF). Piezoelectric behaviour has also been observed in foamed, closed-pore polypropylene (PP). In order to achieve piezoelectricity, such a polypropylene foam is charged in a strong electric field. As a result, electrical breakdowns occur within the pores, generating macrodipoles and polarising the material macroscopically. Such polypropylene ferroelectrets can have a piezoelectric coefficient of several hundred picocoulombs per Newton. In order further to increase the sensitivity of the sensor action, multilayer systems comprising a plurality of foams stacked one above the other have been developed.

Gerhard et al. (2007 Annual Report Conference on Electrical Insulation and Dielectric Phenomena, pages 453 to 456) describe a three-layer ferroelectret in which a polytetrafluoroethylene film provided with a plurality of homogeneous through-holes by mechanical or laser-based drilling is arranged between two homogeneous fluoroethylenepropylene films.

An advantageously simple production method for ferroelectrets having tubular voids of homogeneous size and structure has been described by R. A. P. Altafim, X. Qiu, W. Wirges, R. Gerhard, R. A. C. Altafim, H. C. Basso, W. Jenninger and J. Wagner in the article “Template-based fluoroethylenepropylene piezoelectrets with tubular channels for transducer applications”, accepted for publication in Journal of Applied Physics. In the method described therein, a sandwich arrangement of two FEP foils (FEP: perfluoroethylenepropylene copolymer) and an inteimmediate PTFE mask foil is first prepared. The resulting stack of foils is laminated, the FEP foils are bonded together, and the mask foil is subsequently removed in order to free the voids.

Electromechanical converters, in particular piezoelectric converters, continue to be of increasing interest for commercial applications, for example for sensor and actuator systems. In terms of economy, it is essential that a production process should be usable on an industrial scale.

Accordingly, it is an object of the present invention to provide electromechanical converters of the type mentioned at the beginning and processes for the production thereof which can be carried out simply and inexpensively even on a commercial and industrial scale.

According to the invention, the object is achieved, using an electromechanical converter comprising a polymer layer composite with voids formed therein, in that the polymer layer composite at least comprises
a polymer layer base element comprising a carrier layer having a softening temperature Tg_{A} and an electret layer, extensively bonded thereto, having a softening temperature Tg_{E}, wherein the softening temperature of the carrier layer Tg_{A}>Tg_{E} the softening temperature of the electret layer (Tg_{A}>Tg_{E}) and
a second polymer layer element,
   and the polymer layer base element is at least partially bonded with its electret layer to the second polymer layer element, with the formation of voids.

In other words, the polymer layer composites according to the invention comprise polymer films, in particular polymer foils, which are arranged one above the other in layers, and voids formed at least between in each case two polymer foils. The polymer foils are bonded together between the voids. A fundamental component of the invention is that at least the polymer layer base element is a two-layer polymer composite comprising a carrier layer and an electret layer.

The softening temperature is also called the glass transition temperature and is the temperature at which an amorphous polymer changes from the liquid or rubber-elastic, flexible state into the glass-like or hard-elastic, brittle state. According to the invention, the indicated values and ranges for the softening temperatures Tg of the polymer layers also include, where applicable, the melting temperatures of mixed-phase polymer layers, in particular of semi-crystalline polymer materials.

The polymer layer base element according to the invention is a two-layer structure comprising two polymer layers, in particular polymer films, of different polymer materials, the polymer material of the electret layer having a lower softening temperature Tg_{E} than the polymer material of the carrier layer. The polymer layer base element is also referred to according to the invention as the base element. The base element is preferably formed of continuous polymer layers, in particular polymer films. However, the base element, for example in the electret layer, can also have openings.

According to the invention, the carrier layer performs a carrying and support function for the electret layer and advantageously imparts adequate mechanical and thermal stability to the optionally structured base element and also to the resulting polymer layer composite with the second polymer layer element.

According to the invention the electret layer is extensively bonded, for example over the entire surface, to the carrier layer and is formed according to the invention of a polymer material having good charge storage properties. Owing to the support function of the carrier layer, the electret layer can be made thinner than in a configuration without a carrier layer.

It has been found, surprisingly, that electromechanical converters having the structure according to the invention, as well as having good piezoelectric properties, advantageously exhibit particularly good adhesion between the polymer layers and particularly good mechanical stability. In the structure according to the invention, the carrier layers provide the necessary mechanical and thermal stability. Advantageously, by using a carrier layer in the composite it is possible also to use brittle materials having good electret properties in the polymer layer base element to form electromechanical converters. Accordingly, the electret layers can be chosen according to the invention for their particularly suitable charge storage properties because the necessary mechanical stability is obtained from the carrier layer. A combination of particularly advantageous properties for the electromechanical converter according to the invention can accordingly be achieved in a simple manner.

In an embodiment of the invention, the materials for the polymer layers in a base polymer layer element according to the invention can be so chosen that the softening temperature of the carrier layer Tg_{A} is at least 5° C., for example 10° C., higher than the softening temperature of the electret layer Tg_{E}. This facilitates bonding of the polymer layer base element to the second polymer layer element, in particular by a laminating process. Advantageously, the electret layer can simultaneously act as an adhesive layer; on the other hand, the carrier layer can retain sufficient mechanical stability and, where applicable, can also support the three-dimensional structures of the base element.

According to the invention, the carrier layer can in principle be formed of or comprise polymers or polymer mixtures that permit suitable bonding to the electret layer and exhibit an adequate carrier function and accordingly mechanical and thermal stability. For example, within the context of an advantageous embodiment of the invention, the carrier layer can comprise or be formed of at least one polymer selected from the group consisting of polytetrafluoroethylene (PTFE), polycarbonates and mixtures of those polymers.

Within the context of the present invention, an electret layer can in principle be formed of any polymer or polymer mixture that is suitable for holding charges over a long period, for example several months or years. According to the invention, an electret layer can preferably comprise or be formed of at least one polymer selected from the group consisting of polycarbonates, perfluorinated or partially fluorinated polymers and copolymers, such as polytetrafluoroethylene (PTFE), fluoroethylenepropylene (FEP), perfluoroalkoxyethylenes (PFA), polyesters, such as polyethylene terephthalate (PET) or polyethylene naphthalate (PEN), polyimides, in particular polyether imide, polyethers, polymethyl methacrylates, cycloolefin polymers, cycloolefin copolymers (COC), polyolefins, such as polypropylene, and mixtures of those polymers. Such polymers can advantageously hold a polarisation that has been introduced over a long period.

Within the context of a further embodiment of the invention, in the finished electromechanical converter the carrier layer can have a layer thickness of from ≧6 μm to ≦125 μm, preferably from ≧10 μm to ≦100 μm, for example from ≧15 μm to ≦75 μm, and/or the electret layer can have a layer thickness of from ≧6 μm to ≦125 μm, preferably from ≧10 μm to ≦100 μm, for example from ≧15 μm to ≦75 μm, and/or the polymer layer base element comprising the carrier layer and the electret layer can have an overall layer thickness of from ≧20 μm to ≦250 μm, preferably from ≧30 μm to ≦150 μm, for example from ≧50 μm to ≦100 μm.

In another embodiment, the layer thickness of the electret layer can be thinner relative to the layer thickness of the carrier layer. The carrier layer can additionally be made from cheaper material. As compared with a single, unsupported electret layer without a carrier layer it is additionally possible according to the invention to make each of the electret layers according to the invention thinner than in an embodiment without a carrier layer, because the necessary stability is provided by the carrier layer. Therefore, the electret layer can be configured in a markedly more material-saving manner according to the invention. The resulting electromechanical converter can accordingly be less expensive to produce while having equally good or even improved electromechanical and mechanical properties.

In another embodiment of the invention, the second polymer layer element can comprise at least a first polymer layer with openings and a continuous polymer layer, that is to say without openings or voids within that layer. In other words, a polymer layer structure is provided according to the invention in the form of a sandwich structure comprising at least a polymer layer base element, a continuous polymer layer and an intermediate polymer layer with openings. The polymer layer with openings can impart flexibility to the arrangement as a whole and make it softer along its thickness. The piezoelectric constant d₃₃ and accordingly the sensitivity of the electromechanical converter can thus be increased.

Within the context of a further embodiment of the invention, the second polymer layer element can comprise or be in the form of at least a second polymer layer base element comprising a carrier layer having a softening temperature Tg_{A} and an electret layer, extensively bonded thereto, having a softening temperature Tg_{E}, wherein Tg_{A}>Tg_{E}. In other words, it is possible according to the invention, for example, for two polymer layer base elements together to form a polymer composite with voids formed therein. The electret layers are preferably bonded directly to one another.

According to the invention, it is possible within the context of this embodiment for two identical polymer layer base elements together to farm a polymer composite. In this case, the corresponding polymer layers each consist of the same polymer material. Accordingly, the electret layers, for example, of the two base elements are made of the same material. This applies equally to the carrier layers in this embodiment. If the electret layers are facing one another, as is preferred according to the invention, this can advantageously result in a particularly good bonding ability of the layers and accordingly in improved mechanical stability of the bond.

The invention equally includes a configuration in which two different polymer layer base elements composed of different polymer layers, that is to say carrier and/or electret layers, together form a polymer layer composite. It is possible to use in the two base elements, for example, the same carrier layers but different electret layers having the same or different softening temperatures Tg_{E}, or vice versa. As a result, it is advantageously possible according to the invention to readily adjust the required and desired properties, for example in respect of specific applications of the resulting electromechanical converter. According to the invention, the first base element, for example, can have an electret layer which is particularly well able to store positive charges, while the second base element can have an electret layer which is particularly suitable for storing negative charges, and vice versa. Accordingly, the electrical properties of the resulting electromechanical converter can thus be optimised.

Within the context of an alternative embodiment there can be provided as the polymer layer composite according to the invention, for example, also a sandwich arrangement comprising two polymer layer base elements with an intermediate polymer layer with openings. In other words, the second polymer layer element is formed by a polymer layer with openings and a second base element. In this case, each of the electret layers is preferably bonded to the middle polymer layer with openings. Accordingly, the openings are then closed, preferably by the electret layers, to form voids. In such a polymer layer composite, the carrier layers thus form the sides of the polymer layer base element that are remote from the layer with openings. In this embodiment too, the base elements can be identical or different.

The polymer layer with openings can comprise or be formed of, for example, a thermoplastic elastomer, such as a thermoplastic polyurethane or a thermoplastic polyester. Such materials are advantageously particularly suitable for permitting a polarisation process in the voids and separating the charge layers formed in the polymer films after the charging process, for example they have low electrical conductivity. Improved flexibility can thus be conferred on the arrangement as a whole. In addition, the polymer layer composite can be adjusted in terms of its softness. As a result, the piezoelectric constant d₃₃ and accordingly the sensitivity of the electromechanical converter can be increased further.

Within the context of a further embodiment of the invention, the polymer layer with openings can have a softening temperature Tg_{B} which is lower than the respective softening temperatures of the adjacent polymer layers of the base element, for example lower than the respective softening temperature Tg_{E} of the electret layers, so that the intermediate layer with openings can additionally serve as an adhesive layer for bonding, for example with the electret layers.

Within the context of a further embodiment of the electromechanical converter according to the invention, the first polymer layer with openings can have a layer thickness of from ≧10 μm to ≦250 μm. In particular, the first polymer layer with openings can have a layer thickness of from ≧50 μm to ≦150 μm, preferably from ≧75 μm to ≦100 μm.

The openings of the polymer layer with openings can have the same or different shapes according to the invention. In an embodiment of the electromechanical converter according to the invention, at least some of the openings are of shapes which do not have a circular cross-sectional area.

By combining openings having different shapes it is advantageously possible on the one hand to maximise the total void volume of the resulting voids and on the other hand optionally to adapt the electromechanical, in particular piezoelectric, properties of the electromechanical converter to a specific application.

The openings can be distributed homogeneously or heterogeneously in the polymer layers with openings of the electromechanical converter. In particular, the openings in the first polymer layer with openings can be distributed homogeneously. Depending on the field of application of the electromechanical converter that is to be produced, however, it can also be advantageous purposively to distribute the openings in a polymer layer with openings heterogeneously in a space-resolved manner.

The openings of the polymer layer with openings are formed to pass right through the polymer layer with openings, in particular in the direction towards the continuous polymer layers, in particular electret layers of the polymer layer base elements. The at least first polymer layer with openings can have a plurality of openings of a first shape and a plurality of openings of a second shape and, where appropriate, a plurality of openings of a third shape, et cetera.

Within the context of the present invention, some or all of the openings can, for example, be of shapes which have a cross-sectional area selected from the group consisting of substantially round, for example circular, elliptical or oval, polygonal, for example triangular, rectangular, trapezoidal, rhomboidal, pentagonal, hexagonal, in particular honeycomb-shaped, cross-shaped, star-shaped and partly round and partly polygonal, for example S-shaped, cross-sectional areas. The openings of the layers with openings can, for example, also have a honeycomb-shaped cross-sectional area, or are configured and/or arranged in the manner of a honeycomb. A honeycomb configuration and arrangement of the openings results on the one hand in a very large total void volume. On the other hand, particularly high mechanical stability can be achieved with a honeycomb configuration and arrangement of the openings.

The size of the cross-sectional area can be the same or different in all the openings of the polymer layer with openings. The openings and the voids formed from the openings can be configured in shapes having a small surface area, such as lines, for example curved or straight, single or crossed lines, or circumferential lines of geometric figures, for example a circular line or a circumferential line of a cross, or in the form of structures having a larger surface area, such as rectangles, circles, crosses, et cetera. The shape and dimensions of the voids are preferably so adjusted that the first and second continuous polymer layers, in particular polymer foils, cannot touch one another inside the void perpendicularly to the progression of the layers, and/or that the total void volume obtained after production of the electromechanical converter is as large as possible. In other words, the positive and negative charges applied to the inner surfaces of the voids by a polarisation should in particular not be able to come into contact.

In another embodiment of the electromechanical converter according to the invention, the polymer layer base element and/or the second polymer layer element can be structured, in particular shaped three-dimensionally, in order to form voids in the polymer layer composite with the formation of a vertical profile having bumps and/or depressions. Owing to the possible different configuration of voids it is possible variably to adjust the resonance frequency and piezo activity, and in particular the piezoelectric constant d33, to a particular application. Advantageously, it is possible with the polymer layer composite systems produced according to the invention to achieve high and uniform piezoelectric coefficients even for larger surface areas. This in principle opens up numerous applications for these electromechanical converters.

An electromechanical converter according to the invention can preferably further comprise two electrodes, in particular electrode layers, one electrode being in contact with the carrier layer of the polymer layer base element and the other electrode being in contact with the second polymer layer element, in each case on the surface side remote from the polymer layer base element.

An electromechanical converter according to the invention can also comprise two or more polymer layer composites having voids formed therein which are stacked one on top of the other and each of which comprises a polymer layer base element and a second polymer layer element. In other words, a stack can be formed from two or more polymer composites according to the invention in the form of a single arrangement, which polymer composites are optionally already provided with electrodes and/or polarised with opposite electric charges.

For example, the individual polymer layer composites arranged in a stack one above the other can be sandwich arrangements, wherein the second polymer layer element is formed of a polymer layer with openings and a second polymer layer base element, and wherein the polymer layer with openings is arranged between the electret layers of the first and second polymer layer base element. The openings of the polymer layer with openings are closed on one side by the electret layer of the first polymer layer base element and on the other side by the electret layer of the second polymer layer base element to form voids. It is thereby possible for the carrier layer of a first polymer layer composite and a carrier layer of the second polymer layer composite in a stack each to be in contact with an electrode. Preferably, two adjacent polymer layers of different individual arrangements exhibit the same charge polarisation. In particular, two adjacent polymer layers, for example carrier layers, of different individual arrangements are in contact with the same electrode.

According to the invention, the various embodiments described above can optionally be realised in combination with one another. Regarding further features of an electromechanical converter according to the invention, explicit reference is made to the explanations given in connection with the process according to the invention and the use according to the invention.

The invention relates further to a process for the production of an electromechanical converter, in particular an electromechanical converter according to the various embodiments described above alone or in combination with one another.

The process according to the invention for the production of an electromechanical converter at least comprising a polymer layer composite with voids formed therein comprises the steps:
A) providing a polymer layer base element comprising a carrier layer having a softening temperature Tg_{A} and an electret layer, extensively bonded thereto, having a softening temperature Tg_{E}, wherein Tg_{A}>Tg_{E},
B) providing a second polymer layer element,
C) arranging the polymer layer base element on the second polymer layer element, the electret layer facing the second polymer layer element; and
D) bonding the polymer layer base element to the second polymer layer element by means of lamination to form a polymer layer composite having voids formed therein, the chosen laminating temperature T_{L} being lower than the softening temperature Tg_{A} and greater than or equal to the softening temperature Tg_{E}.

The process according to the invention is inexpensive and simple to carry out because established process steps can be used with little adaptation. Surprisingly, electromechanical converters that are particularly mechanically stable and have good piezoelectric properties can be obtained by a process according to the invention. Advantageously, the choice according to the invention of the polymer layers, in particular of the electret layer in the polymer layer base element, having a lower softening temperature Tg_{E} as compared with the carrier layer, facilitates lamination of the polymer layer composite and permits particularly good bonding of the polymer layers with one another.

The laminating temperature is preferably so chosen that it is close to the softening temperature Tg_{E} of the electret layer. The temperature difference between the laminating temperature T_{L} and the softening temperature Tg_{E} of the electret layer ΔT (T_{L}, T_{E}) can be less than 10° C., preferably less than 5° C. According to the invention, T_{L}<Tg_{A} and T_{L}≧Tg_{E} apply for the laminating temperature.

In a process variant according to the invention, the provision in step A) of the polymer layer base element, comprising a carrier layer and an electret layer extensively bonded thereto, can be carried out by coextrusion or by solvent-cast technology. These fundamentally established processes of film production can easily be used according to the invention and, in addition, can advantageously be automated.

Within the context of another embodiment of the process according to the invention, step A) and/or step B) can comprise the structuring and/or three-dimensional shaping of the polymer layer base element and/or of the second polymer layer element in order to form a vertical profile, that is to say in order to form bumps and indentations. This can be effected by an embossing process, for example. The embossing process can be carried out equally preferably using a structured roller or by means of an embossing stamp. Both when using a structured roller and when using a structured embossing stamp, a vertical profile can in each case be transferred to the polymer layers. It is also possible to apply positive or negative forms to the surface of the embossing tool, that is to say of the roller or of the embossing stamp, and/or to transfer the structuring three-dimensionally to the polymer layer base element and/or the second polymer layer element or only to one surface side of a polymer layer, for example the electret layer. Structuring can be carried out directly after extrusion of the polymer layers or as an individual process, for example in a hot press. Also included in the invention is the processing of the respective polymer layer elements and/or individual polymer foils of both surface sides by means of an embossing tool. For example, a polymer layer base element and/or a second polymer layer element can be embossed and thereby structured from the upper and the lower side using a structured roller in each case.

In another alternative embodiment of the process, structuring of the polymer layer elements and/or of the polymer foils in step A) or step B) can be carried out by deformation of the optionally heated polymer layers or polymer layer elements, that is to say base element or second polymer layer element, with the application of pressure, for example by means of compressed air or another gas, in a moulding tool with an optionally pretempered contoured insert. For example, a polymer layer element can be heated to a temperature close to the softening temperature (glass transition temperature) of at least one of its polymer layers, for example of the carrier layer, and then suddenly deformed by being subjected to compressed air at from ≧20 to ≦300 bar. For example, polycarbonate foils (for example Macrofol from Bayer MaterialScience AG) can be heated to just below the glass transition temperature at 130-140° C. The foils can then be subjected to compressed air at 250 bar and pressed onto a moulding tool and are able to adapt to the contour of the tool and be permanently deformed. According to the invention, this can also be transferred to two-layer polymer layer base elements and/or second polymer layer elements.

The mentioned structuring variants have the advantage that it is possible to transfer the desired profile to the polymer layers, in particular polymer foils, accurately in terms of position. Both the shape and the dimensions of the voids then formed in the polymer layer composite can advantageously be chosen almost freely with the methods described above and can be adapted to the desired mechanical and electrical requirements of a desired application, in dependence on the chosen polymer layer materials and their properties and the respective layer thicknesses. The combination of the polymer layer properties and the shape and dimensions of the formed voids is so chosen that the foil sections, which are to be kept apart, are not able to come into contact in any applications. The mentioned structuring methods have the further advantage that they can be automated and can optionally be carried out as a continuous process.

In another embodiment, the process can further comprise process step E): charging the arrangement obtained in process step D), in particular the inner surfaces of the voids formed in the polymer layer composite, with opposite electric charges. Charging can be carried out, for example, by tribocharging, electron beam bombardment, application of an electric voltage to already existing electrodes, or corona discharge. In particular, charging can be carried out by a two-electrode corona arrangement. The stylus voltage can be at least ≧20 kV, for example at least ≧25 kV, in particular at least ≧30 kV. The charging time can be at least ≧20 seconds, for example at least ≧30 seconds, in particular at least ≧1 minute. A corona treatment can advantageously also be used successfully on a large scale.

Before and/or after the electric charging of the inner surfaces of the voids formed in the polymer layer composite in step E), the process can further comprise process step F): application of an electrode to the polymer layer base element, in particular to a preferably continuous carrier layer, and of an electrode to the second polymer layer element. Within the context of the present invention, however, the electrodes can also already be provided together with the polymer layer base element and/or the second polymer layer element, in particular in each case can be formed thereon.

The electrodes can be applied by means of processes known to the person skilled in the art. Suitable processes are, for example, established processes such as sputtering, spraying, vapour deposition, chemical vapour deposition (CVD), printing, doctor blade application, spin coating. The electrodes can also be adhesively bonded in prefabricated form.

The electrode materials can be conductive materials known to the person skilled in the art. There are suitable for that purpose, for example, metals, metal alloys, semiconductors, conductive oligomers or polymers, such as polythiophenes, polyanilines, polypyrroles, conductive oxides or mixed oxides, such as indium tin oxide (ITO), or polymers filled with conductive fillers. Examples of suitable fillers for polymers filled with conductive fillers include metals, materials based on conductive carbon, for example carbon black, carbon nanotubes (CNTs), or conductive oligomers or polymers. The filler content of the polymers is preferably above the percolation threshold, which is characterised in that the conductive fillers form continuous electrically conductive paths.

Within the context of the present invention, the electrodes can also be structured. A structured electrode can be in the form of, for example, a conducting coating in strip or lattice form. It is thereby additionally possible to influence the sensitivity of the electromechanical converter and adapt it to specific applications. For example, the electrodes can be so structured that the converter has active and passive regions. In particular, the electrodes can be so structured that, in particular in sensor mode, signals are detected in a space-resolved manner and/or, in particular in actuator mode, the active regions can purposively be triggered. This can be achieved, for example, by providing the active regions with electrodes while the passive regions do not have electrodes.

In another embodiment of the process according to the invention, steps A), B), C), D), E) and/or F) can in particular be carried out as a continuous roll-to-roll process. Advantageously, the production of the electromechanical converter can accordingly be carried out at least partially as a continuous process, preferably as a roll-to-roll process. This is particularly advantageous for the use of the processes on a commercial and industrial scale. Automation of at least part of the production process simplifies the process that is provided and permits the inexpensive production of the electromechanical, in particular piezoelectric, converter. According to the invention, advantageously all the steps of the process can be amenable to automation.

Within the context of a further process variant according to the invention, a process step G) can comprise the stacking of two or more arrangements obtained in process steps D), E) or F) one on top of the other. In other words, a stack can advantageously be formed from two or more polymer composites according to the invention which are optionally already provided with electrodes and polarised.

Regarding further features of a process according to the invention, explicit reference is made to the explanations given in connection with the electromechanical converter according to the invention and its use.

The present invention further provides the use of an electromechanical, in particular piezoelectric, converter according to the invention as a sensor, generator and/or actuator, for example in the electromechanical and/or electroacoustic sector. In particular, electromechanical converters according to the invention can be used in the field of obtaining energy from mechanical vibrations (energy harvesting), acoustics, ultrasound, medical diagnostics, acoustic microscopy, mechanical sensor systems, in particular pressure, force and/or strain sensor systems, robotics and/or communication technology, in particular in loudspeakers, vibration transducers, light deflectors, membranes, modulators for fibre optics, pyroelectric detectors, capacitors and control systems.

Regarding further features of a use according to the invention, explicit reference is made to the explanations given in connection with the process according to the invention and the electromechanical converter according to the invention.

The production according to the invention and the structure of an electromechanical, for example piezoelectric, converter according to the invention is explained in greater detail with reference to the figures, the following description of the figures and the following test descriptions. It is to be noted that the drawings and the test descriptions are only descriptive in nature and are not intended to limit the invention in any way.

In the drawings:

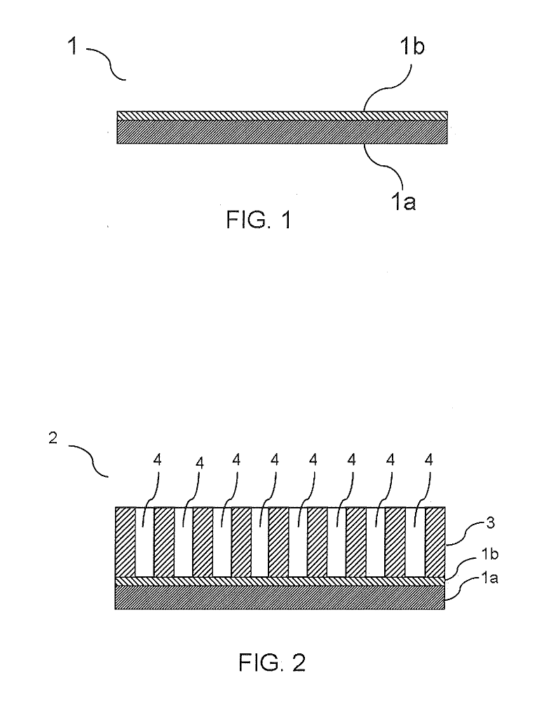

FIG. 1 shows a schematic cross-section through a polymer layer base element;

FIG. 2 shows a schematic cross-section through an embodiment of a second polymer layer element;

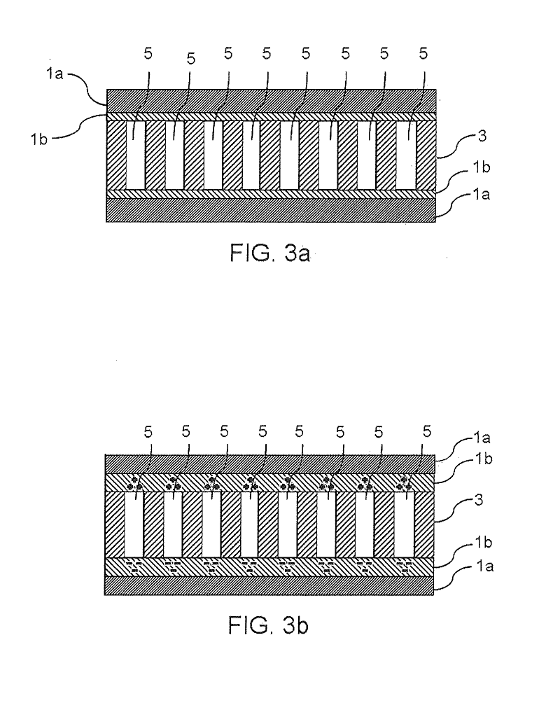

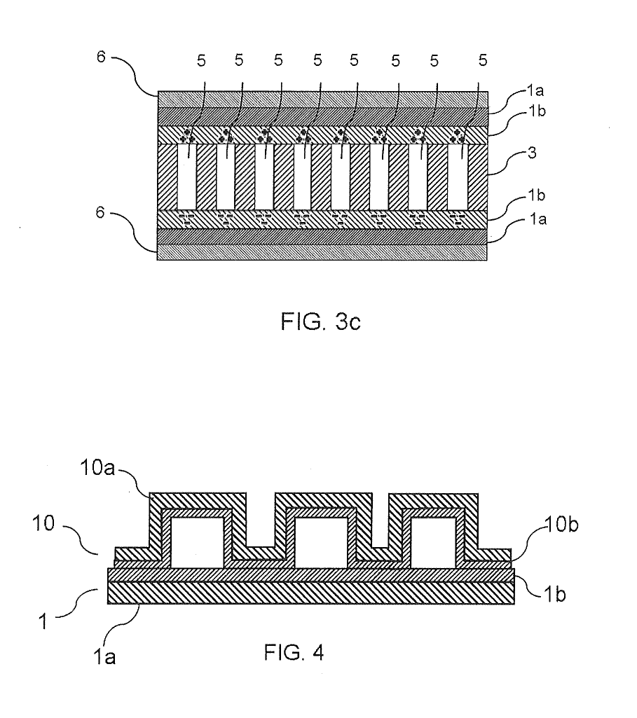

FIG. 3a shows a schematic cross-section through a polymer layer composite in the form of a sandwich arrangement having two polymer layer base elements and an intermediate polymer layer with openings;

FIG. 3b shows a schematic cross-section through the arrangement shown in FIG. 3a after the charging process;

FIG. 3c shows a schematic cross-section through the arrangement shown in FIG. 3b after the charging process and after the application of electrodes;

FIG. 4 shows a schematic cross-section through an electromechanical converter comprising a three-dimensionally structured base element bonded to an unstructured base element.

FIG. 1 shows a schematic cross-section through a polymer layer base element 1 comprising a carrier layer 1a having a softening temperature Tg_{A} and an electret layer 1b, extensively bonded thereto, having a softening temperature Tg_{E}. FIG. 1 shows that the polymer layer base element 1 is a two-layer polymer element, wherein the polymer layers, that is to say the carrier layer 1a and the electret layer 1b, are formed preferably continuously, that is to say substantially without openings or gas inclusions. The softening temperature Tg_{E} of the electret layer 1b is lower according to the invention than the softening temperature Tg_{A} of the carrier layer 1a. The polymer material of the carrier layer 1a can accordingly provide thermal and mechanical stability, while the electret layer 1b can be so formed that it can on the one hand advantageously serve as an adhesive layer for a further polymer layer element and on the other hand can provide good charge storage properties. By means of this two-layer base element 1 according to the invention, therefore, advantageous properties combined with one another can be introduced into a polymer composite, in particular a piezoelectric converter.

FIG. 2 shows a schematic cross-section through an embodiment of a second polymer layer element 2. This polymer layer element 2 forms a polymer layer composite comprising a polymer layer base element 1 and a polymer layer 3, bonded thereto, which has openings 4. FIG. 2 shows that the polymer layer base element 1 in this embodiment of the second polymer layer element 2 is bonded with its electret layer 1b to the polymer layer 3 with openings 4.

FIG. 3a shows a schematic cross-section through a polymer layer composite in the form of a sandwich arrangement comprising two polymer layer base elements 1 and an intermediate polymer layer with openings 4. In other words, the second polymer layer element 2 according to the invention in this embodiment comprises a polymer layer 3 with openings 4 and a second polymer layer base element 1 bonded thereto. FIG. 3a shows that both polymer layer base elements 1 in the polymer layer composite are bonded with their electret layer 1b to the polymer layer 3 with openings 4. The openings 4 of the polymer layer 3 are closed by the electret layer 1b of the first base element 1 on one side and by the electret layer 1b of the second base element 1 on the other side to form voids 5.

FIG. 3b shows a schematic cross-section through the arrangement shown in FIG. 3a after polarisation according to step E) of the process according to the invention. FIG. 3b shows that the negative charges on the first continuous electret layer 1b and the positive charges on the second continuous electret layer 1b are separated from one another and localised. Because the electret layers 1b can be chosen according to the invention for their good charge storage properties, particularly good piezoelectric properties of the resulting electromechanical converters can thereby be achieved. An optimisation can be achieved in this connection by using different materials for the two electret layers 1b, of which one is a particularly good charge storage means for positive charges and, correspondingly, the other is a particularly good charge storage means for negative charges.

FIG. 3c shows a schematic cross-section through the arrangement shown in FIG. 3a after the charging process and after the application of electrodes 6. The carrier layers 1a of the first and second base elements 1 are each in contact with an electrode 6. The electrodes 6 are each in the form of electrode layers on the surface sides of the first and second carrier layers 1a that are arranged on the side of the polymer layer base elements 1 that is remote from the polymer layer 3 with openings 4.

FIG. 4 shows a schematic cross-section through an electromechanical converter according to the invention comprising a three-dimensionally structured base element 10 bonded to an unstructured base element 1. FIG. 4 shows that the two base elements 1, 10 are bonded to one another, preferably by means of lamination, with their electret layers 1b, 10b facing one another, to form voids 5. According to the invention, the carrier layers 1a, 10a and/or electret layers 1b, 10b of the two base elements 1, 10 can be made of the same material or of different polymer materials. If electret layers 1b, 10b of the same polymer material are used, particularly good bonding of the electret layers 1b, 10b with one another can be obtained. If, on the other hand, in the case of different electret layers 1b, 10b, there is chosen for the first structured base element 10, for example, an electret layer 10b of a polymer material that can store positive charge particularly well and, by contrast, the electret layer 1b of the second base element 1 is made from a polymer material that can store negative charges particularly well, the electrical properties of the resulting electromechanical converter can be optimised. Structuring of the first base element 10 can be achieved, for example, by an embossing process.

### EXAMPLE 1

### Production of a Piezoelectric Converter

For a first and a second continuous polymer layer base element having an overall thickness of 60 μm there was produced a coextrudate of in each case the same polycarbonate APEC as the carrier layer having a softening temperature Tg_{A}=180° C. and a thickness of 50 μm and in each case the same polycarbonate Makrolon® 3108 as the electret layer having a softening temperature Tg_{E}=150° C. and a thickness of 10 μm. The first polymer layer base element was structured three-dimensionally by means of roller embossing to form a vertical profile, while the second base element, as the second polymer layer element, was left flat and unstructured. The two base elements, with their electret layers facing one another, were bonded together by means of lamination at 140° C. with the formation of voids, so that a polymer layer composite as shown in FIG. 3 was obtained. For charging the arrangement, corona treatment at 30 kV, 60 s was chosen, resulting in a Paschen discharge in the formed voids and the formation of opposite charges on the opposing polymer layers. If a pressure is exerted on the arrangement according to the invention, a voltage is produced. A piezoelectric constant d₃₃ of 70 pC/N was achieved. The polymer layer composite exhibited surprisingly good mechanical stability, good adhesion of the polymer layers to one another and good piezoelectric properties.

### EXAMPLE 2

### Production of a Polymer Layer Base Element According to the Invention

In order to produce a base element, a polycarbonate film APEC having a softening temperature

Tg_{A}=180° C. and a polymer film of cycloolefin copolymer (COC) having a softening temperature Tg_{E}=170° C. were coextruded. A base element having an overall thickness of 60 μm was obtained, the carrier layer having a thickness of 50 μm and the electret layer having a thickness of 10 μm. Cycloolefin copolymer (COC) has particularly good charge storage properties but tends to be brittle, so that its usability is normally limited. Surprisingly, it was possible to overcome this according to the invention by using a carrier layer in the polymer layer base element, so that the outstanding electret properties of the cycloolefin copolymer can be converted into electromechanical converters according to the invention combined with good mechanical and thermal properties.

1-15. (canceled)

16. An electromechanical converter at least comprising a polymer layer composite having voids formed therein,
characterised in that
the polymer layer composite at least comprises
a polymer layer base element (1) comprising a carrier layer (1a) having a softening temperature Tg_{A} and an electret layer (1b), extensively bonded thereto, having a softening temperature Tg_{E}, wherein Tg_{A}>Tg_{E}, and
a second polymer layer element (2), wherein
the polymer layer base element (1) is at least partially bonded with its electret layer (1b) to the second polymer layer element (2) with the formation of voids (5).

17. The electromechanical converter according to claim 16,
characterised in that
the carrier layer (1a) comprises or is formed of at least one polymer selected from the group consisting of polycarbonates and mixtures of those polymers.

18. The electromechanical converter according to claim 16,
characterised in that
the electret layer (1b) comprises or is formed of at least one polymer selected from the group consisting of polycarbonates, perfluorinated or partially fluorinated polymers and copolymers, such as polytetrafluoroethylene (PTFE), fluoroethylenepropylene (FEP), perfluoroalkoxyethylene (PFA), polyesters, such as polyethylene terephthalate (PET) or polyethylene naphthalate (PEN), polyimides, in particular polyether imide, polyethers, polymethyl methacrylates, cycloolefin polymers, cycloolefin copolymers (COC), polyolefins, such as polypropylene, and mixtures of those polymers.

19. The electromechanical converter according to claim 16,
characterised in that,
in the finished electromechanical converter,
the carrier layer (1a) has a layer thickness of from ≧6 μm to ≦125 μm, and/or
the electret layer (1b) in the finished electromechanical converter has a layer thickness of from ≧6 μm to ≦125 μm, and/or
the polymer layer base element (1), comprising the carrier layer (1a) and the electret layer (1b), has an overall layer thickness of from ≧6 μm to ≦250 μm.

20. The electromechanical converter according to claim 16,
characterised in that,
in the finished electromechanical converter, the layer thickness of the electret layer (1b) is thinner relative to the layer thickness of the carrier layer (1a).

21. The electromechanical converter according to claim 16,
characterised in that
the second polymer layer element (2) comprises at least a first polymer layer (3) with openings (4).

22. The electromechanical converter according to claim 16,
characterised in that
the second polymer layer element (2) comprises or is in the form of at least a second polymer layer base element (1) comprising a carrier layer (1a, 10a) having a softening temperature Tg_{A} and an electret layer (1b, 10b), extensively bonded thereto, having a softening temperature Tg_{E}, wherein Tg_{A}>Tg_{E}.

23. The electromechanical converter according to claim 16,
characterised in that
the polymer layer base element (1) and/or the second polymer layer element (2) are structured and/or three-dimensionally shaped with the formation of bumps and/or indentations in order to form voids (5) in the polymer layer composite.

24. A process for the production of an electromechanical converter at least comprising a polymer layer composite with voids (5) formed therein,
characterised by
the steps:
A) providing a polymer layer base element (1) comprising a carrier layer (1a) having a softening temperature Tg_{A} and an electret layer (1b), extensively bonded thereto, having a softening temperature Tg_{E}, wherein Tg_{A}>Tg_{E},
B) providing a second polymer layer element (2),
C) arranging the polymer layer base element (1) on the second polymer layer element (2), the electret layer (1b) facing the second polymer layer element (2); and
D) bonding the polymer layer base element (1) to the second polymer layer element (2) by means of lamination to form a polymer layer composite with voids (5) formed therein, the chosen laminating temperature T_{L} being lower than the softening temperature Tg_{A} and greater than or equal to the softening temperature Tg_{E}.

25. A process according to claim 24,
characterised in that
the temperature difference between the laminating temperature T_{L} and the softening temperature Tg_{E} of the electret layer (1b) ΔT (T_{L}, Tg_{E}) is ≦10° C.

26. The process according to claim 24,
characterised in that
in step A) the provision of the polymer layer base element (1), comprising a carrier layer (1a) and an electret layer (1b) extensively bonded thereto, is carried out by coextrusion or by solvent-cast technology.

27. The process according to claim 24,
characterised in that
step A) and/or step B) comprises the structuring and/or three-dimensional shaping of the polymer layer base element (1) and/or of the second polymer layer element (2).

28. The process according to claim 24,
characterised in that
the process comprises as a further step
E) the electrical charging of the inner surfaces of the voids (5) formed in the polymer layer composite with opposite electrical charges.

29. The process according to claim 24,
characterised in that
the process comprises, before and/or after an electrical charging of the inner surfaces of the formed voids (5) in step E), in a step
F) the application of electrodes (6) to the polymer layer base element (1) and/or to the second polymer layer element (2).

30. The process according to claim 24,
characterised in that
it comprises as a process step
G) the stacking one on top of the other of two or more arrangements obtained in process steps D), E) and/or F).
